(19) United States
(12) Patent Application Publication
(10) Pub. No.: US 2016/0300259 A1
(43) Pub. Date: Oct. 13, 2016

(54) RECEIVING VIDEO AD TRACKING INFORMATION

(71) Applicant: comScore, Inc., Reston, VA (US)

(72) Inventors: Rajesh BASHETTY, Reston, VA (US); Yunzhen WANG, Reston, VA (US); Thomas Pottjegort, Ashburn, VA (US); Alfonso Corretti Gerbaudo, Lleida (ES)

(21) Appl. No.: 14/682,038

(22) Filed: Apr. 8, 2015

(51) Int. Cl. G06Q 30/02; H04N 21/258; H04N 21/442; H04N 21/81

(52) U.S. Cl. CPC G06Q 30/0242; G06Q 30/0276; G06Q 30/0277; H04N 21/812; H04N 21/25891; H04N 21/44222; H04N 21/44204

(57) ABSTRACT

Receiving tracking information at an analysis network is disclosed. Initially, a first link to a first video ad serving template including first instructions and a second link to a video creative is received at the analysis network and from a creative provider. A second video ad serving template is then generated based on the first link to the first video ad serving template. The second video ad serving template includes the first link to the first video ad serving template and a third link to second instructions for generating second tracking information. A link to the second video ad serving template is forwarded from the analysis network to the creative provider. A request for the second instructions is then received at the analysis network and from the content provider. The second instructions are then forwarded from the analysis network to the content provider. Second tracking information generated by the second instructions is then received at the analysis network from the content provider.

### FIELD OF THE DISCLOSURE

This disclosure generally relates to receiving tracking information, and more particularly relates to receiving video ad tracking information at an analysis network.

### BACKGROUND ART

Internet audience measurement may be useful for a number of reasons. For example, some organizations may want to understand the size and growth of their audiences or technologies. Understanding such consumer behavior, in addition to how consumers interact with a particular web site or group of websites, may help organizations make decisions to improve their traffic flow or better achieve the objectives of their website. In addition, understanding Internet audience visitation and habits may be useful for informing advertising planning, buying, and selling decisions.

In the area of online advertising, a company that provides goods or services, or a non-profit entity advancing a particular cause, for example, may pay a website owner, known as a publisher or content provider, to include their advertisements or creatives into one or more of the content provider's webpages. A creative provider may have its creatives displayed through multiple content providers or third-party advertising networks/brokers, and a content provider may display creatives from multiple creative providers or third party advertising networks/brokers on any one of its webpages.

In order to better understand consumer behavior, information related to the viewing of these creatives is typically tracked. The specific instructions of what and how to track information related to the display of these creatives have typically been provided by the creative provider or advertising networks/brokers. However, it may be desirable to have a third-party analysis network provide the instructions of what and how to track information related to the display of video advertisements because the analysis network may have the ability to track different information from more sources than the creative provider or advertising networks/brokers.

Accordingly, there is a need to enable an analysis network to track information related to advertisements.

### SUMMARY OF THE DISCLOSURE

The foregoing needs are met, to a great extent, by the computer-implemented method for receiving tracking information at an analysis network described below. Initially, a first link to a first video ad serving template including first instructions and a second link to a video creative is received at the analysis network and from a creative provider. A second video ad serving template is then generated based on the first link to the first video ad serving template. The second video ad serving template includes the first link to the first video ad serving template and a third link to second instructions for generating second tracking information. A link to the second video ad serving template is forwarded from the analysis network to the creative provider. A request for the second instructions is then received at the analysis network and from the content provider. The second instructions are then forwarded from the analysis network to the content provider. Second tracking information generated by the second instructions is then received at the analysis network from the content provider.

In some aspects, the second instructions can cause the content provider to request the first video ad serving template from the creative provider. A request for the first video ad serving template can be received at the creative provider from the content provider, and the first video ad serving template can be forwarded from the creative provider to the content provider.

In some aspects, the first tracking and/or second tracking information can be at least one of an indication that playback of the video creative begins, an indication that playback of the video creative has ended, an indication that playback of the video creative is at a first, second, or third quartile of a video creative duration, an indication that playback of the video creative is muted or un-muted, an indication that playback of the video creative is paused or un-paused, and an indication that playback of the video creative is in a full-screen mode. The second tracking information can be different from the first tracking information. The first instructions can be configured to cause a processor of an end-user device to generate the first tracking information and the second instructions can be configured to cause a processor of an end-user device to generate the second tracking information.

The first instructions and the second instructions can be compliant with the Video Player Ad-Serving Interface Definition standard. In some aspects, the second tracking information can be analyzed to determine metrics for viewing of and interaction with the video creative. The metrics can be at least one of location of the video creative on a screen of a client device, visibility of the video creative on a screen of a client device, and whether a threshold of visibility for the video creative has been met.

A system for receiving tracking information at an analysis network, where the system includes at least one processor connected to at least one storage device is also disclosed according to some aspects. A storage device storing a computer program for receiving tracking information at an analysis network, where the computer program includes one or more code segments is also disclosed according to some aspects.

Certain aspects of receiving tracking information at the analysis network have been outlined such that the detailed description thereof herein may be better understood and in order for the present contribution to the art may be better appreciated. There are, of course, additional aspects of the disclosure that will be described below and which will form the subject matter of the claims appended hereto.

In this respect, before explaining at least one aspect of receiving the tracking information at the analysis network in detail, it is to be understood that the receiving of the tracking information at the analysis network is not limited in its application to the specific steps or details set forth in the following description or illustrated in the drawings. Rather, other aspects in addition to those described can be practiced and carried out in various ways. Also, it is to be understood that the phraseology and terminology employed herein, as well as the Abstract, are for the purpose of description and should not be regarded as limiting.

As such, those skilled in the art will appreciate that the conception upon which this disclosure is based may readily be utilized as a basis for the designing other structures, methods, and systems for carrying out the several purposes of the receiving of the tracking information at the analysis network. It is important, therefore, that the claims be regarded as including such equivalent constructions insofar as they do not depart from the spirit and scope of the disclosure.

### BRIEF DESCRIPTION OF THE DRAWINGS

In order that the disclosure may be readily understood, aspects of this disclosure are illustrated by way of examples in the accompanying drawings.

FIG. 1 illustrates an exemplary hardware and network configurations between a content provider, an analysis network, and a creative provider.

FIG. 2 illustrates an exemplary webpage of a content provider.

FIG. 3 illustrates an example of a process for generating a second video ad serving template.

FIGS. 4A-4B illustrate an example of a process for receiving second tracking information at an analysis network.

The same reference numbers are used in the drawings and the following detailed description to refer to the same or similar parts.

### DETAILED DESCRIPTION

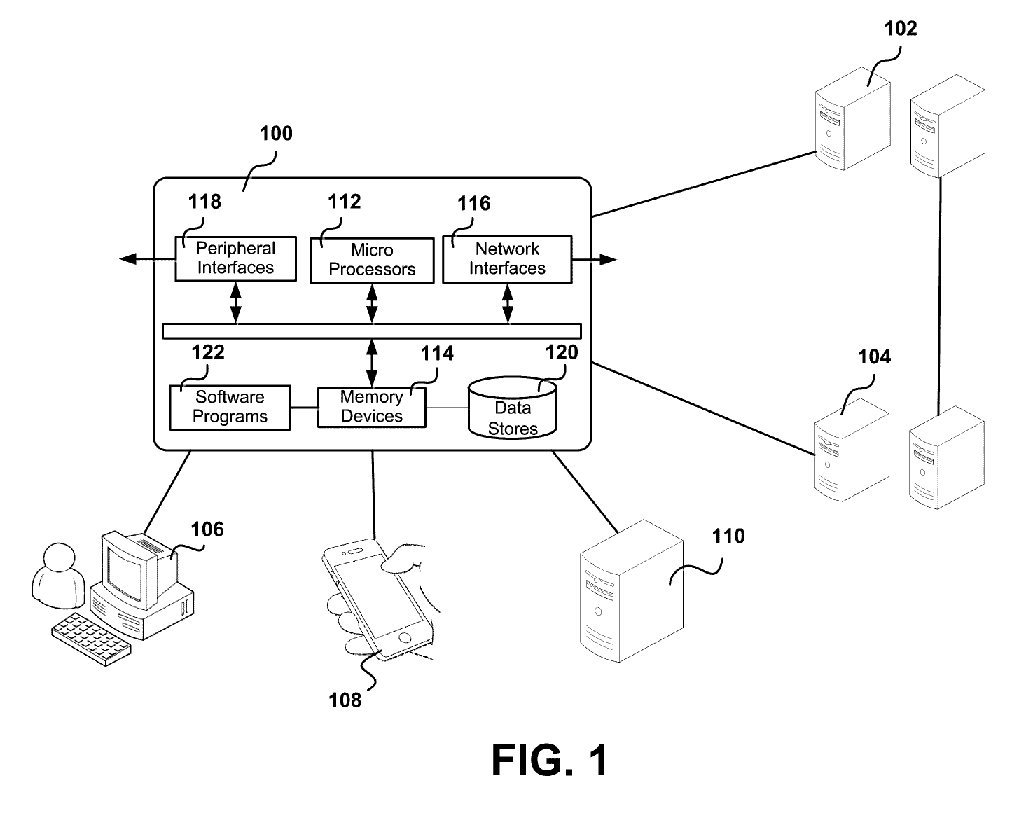

FIG. 1 illustrates exemplary hardware and network configurations for various devices that may be used to perform one or more operations of the described aspects. As shown, a content provider 100, an analysis network 102, and a creative provider 104 are in communication with one another. A content provider 100 may be a website owner or content publisher. The content provider 100 may also be an advertisement agency or broker that may provide advertisements to a website owner or content publisher. The creative provider 104 may be a company seeking to market or sell products or services, or an advertisement agency or broker that may provide advertisements to a content provider 100. The analysis network 102 may be a third-party seeking to receive information related to the advertisements received by the content provider 100 and provided by the creative provider 104 to determine metrics associated with the viewing of and interaction with the advertisements.

The content provider 100 may be in communication with a plurality of client devices. A client may be anyone who is viewing a webpage or other web or application content of the content provider 100. As further described below, the client devices may be the devices that receive an advertisement. The client devices may include a personal computing device 106, such as a desktop or laptop computer, a mobile device 108, such as a smartphone or tablet, a kiosk terminal, a Global Positioning System (GPS) device, etc. The client device may receive client-side code for generating tracking information related to the advertisement from one or more external devices 110, such as a web server involved with serving webpages, advertisements, creative, or other information to the client device. The content provider 100 can be a website owner or content publisher, as well as any client devices in communication with the website owner or content publisher.

Although only the hardware configurations for the content provider 100 are shown in FIG. 1, each of the content provider 100, the analysis network 102, and the creative provider 104, may include microprocessors 112 of varying core configurations and clock frequencies. These entities may also include one or more memory devices or computer-readable media 114 of varying physical dimensions and storage capacities, such as flash drives, hard drives, random access memory, etc., for storing data, such as images, files, and program instructions for execution by one or more microprocessors 112. These entities may include one or more network interfaces 116, such as Ethernet adapters, wireless transceivers, or serial network components for communicating over wired or wireless media using protocols, such as Ethernet, wireless Ethernet, code divisional multiple access (CDMA), time division multiple access (TDMA), etc. These communication protocols may be used to communicate between the content provider 100, the analysis network 102, and the creative provider 104. These entities may also have one or more peripheral interfaces 118, such as keyboards, mice, touchpads, computer screens, touchscreens, etc. for enabling human interaction with and manipulation of the content provider 100, the analysis network 102, and/or the creative provider 104 devices.

The content provider 100, the analysis network 102, and/or the creative provider 104 devices may have the computer-readable media 114 physically or logically arranged or configured to provide for or store one or more data stores 120, such as one or more file systems or databases, and one or more software programs 122, which may contain interpretable or executable instructions for performing one or more of the disclosed aspects. The components may comprise any type of hardware, including any necessary firmware or software for performing the disclosed aspects. The components may also be implemented in part or in whole by electronic circuit components or processors, such as application-specific integrated circuits (ASIC) or field-programmable gate arrays (FPGAs).

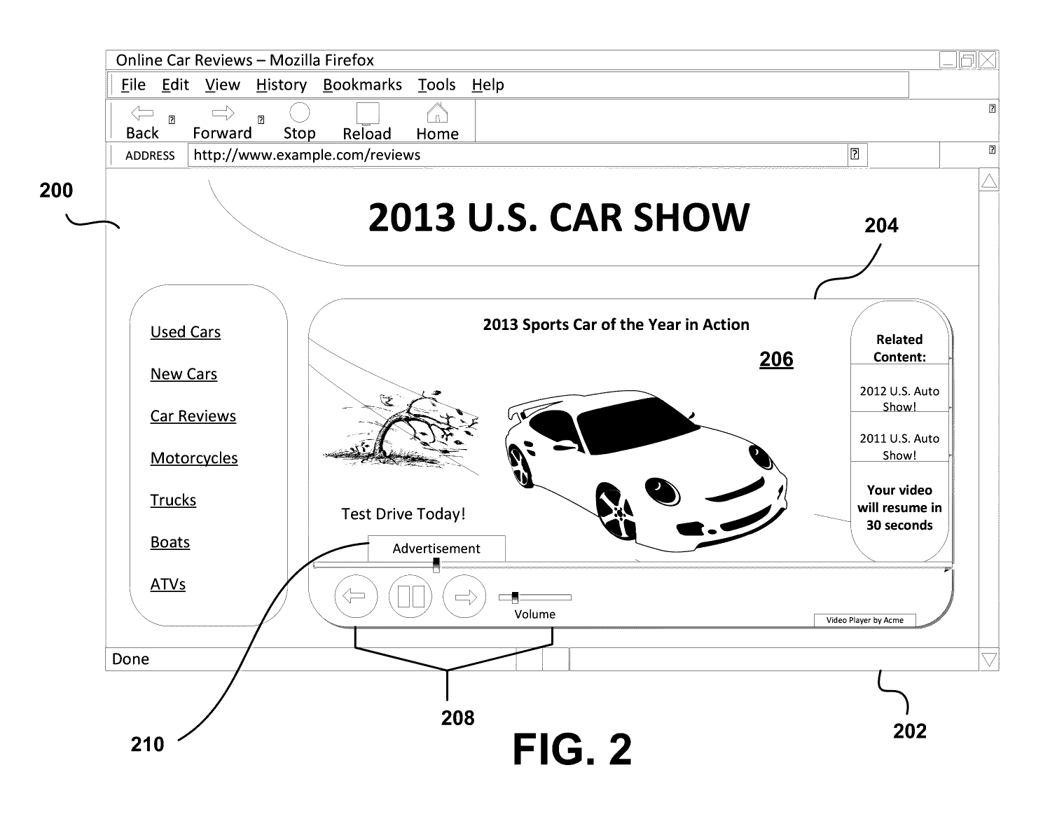

FIG. 2 is a diagram depicting an exemplary webpage 200 of a content provider 100. The webpage 200 may rendered by a web browser 202 on a client device and may be displayed on a screen of the client device. The webpage 200 may have instructions for embedding a video player 204 as a part of the content to be displayed on the page. The video player 204 may be configured to play video content, such as video advertisements, to open executable files, such as Shockwave Flash files, and to process tracking instructions. The video player 204 may be a separate component that is downloaded and executed by the web browser 202, such as an Adobe Flash, Apple Quicktime, or Microsoft Silverlight object.

The video player 204 may also be a component of the web browser itself, such as a HTML 5.0 video player, or the video player may be any other type of component able to render and play video content within the web browser 202. The video player 204 may have a video pane 206 that is reserved for displaying video content. The video pane 206 may be partially or completely obstructed by video controls 208, depending on the user interface design of the video player 204. The video content may be presented within the video pane 206 or may be presented in other areas within the video player 204.

In some aspects, the video player 204 may be configured to play video advertisements, also known as the creative 210, in addition to featured video content. The video player 204 may play a creative 210 at various times such as, for example, before the playback of the featured video content, after the playback of the featured video content, at some time in the middle of the playback of the featured video content, or concurrently with the playback of the featured video content. The video advertisement may be hosted by a content provider 100 or a creative provider 104.

The video player 204 may request the creative 210 directly from the content provider 100 or creative provider 104. The selection of the creative 210 to be played may be based on a variety of criteria, including the topical classification of the content provider 100, the topical classification of the webpage 200, demographic information associated with the user viewing the webpage 200, the topical or demographic classification of the featured video content and/or any other form of criteria. In some aspects, the criteria used to select the creative 210 to be played may be provided by the content provider 100 of the webpage 200.

The video player 204 may receive metadata associated with the creative 210. In some aspects, the metadata may be received along with the creative 210 itself. For example, the metadata may be received as part of the file generated in accordance with the Video Ad Serving Template (VAST) protocol. In another aspect, the metadata may be included as part of a Video Player-Ad Interface Definition (VPAID) file instead of, or in addition to, a VAST file. In other aspects, the metadata information may be received separately in advance of or after receipt of the creative 210. In yet other aspects, the metadata information may be included as parameters in a URI or other address associated with the creative, such as the URI or address of a server that may be in the communication chain leading to the creative 210.

In some aspects, the metadata information associated with the creative 210 may include callback instructions, which the video player 204 may extract and/or recognize. In some aspects, the video player 204 may be configured to execute the event callback instructions when certain events associated with the creative 210 occur. For example, a VAST file may contain tracking URIs to be requested when certain tracking events occur. Tracking events may be events related to the playback of the creative 210, such as when playback of the creative 210 begins, when at least 25% of the creative 210 has been played, when at least 50% of the creative has been played, when at least 75% of the creative 210 has been played, when the complete creative 210 has been played, etc. The tracking events may also include events related to user interaction with the video player 204 during the playing of the creative 210, such as pausing the playback of the creative 210, unpausing or resuming playback of the creative 210, fast forwarding playback of the creative 210, toggling a full-screen mode of the video player 204, etc.

In some aspects, when a tracking event associated with an event callback instruction occurs, the video player 204 may execute the event callback instruction. For example, if a VAST file associated with a creative 210 and containing a tracking URI to be requested when a creative 210 begins (i.e., the tracking event) is received by the video player 204, the video player 204 may generate a request to the tracking URI (i.e., execute the event callback instruction) when it begins playing the creative 210.

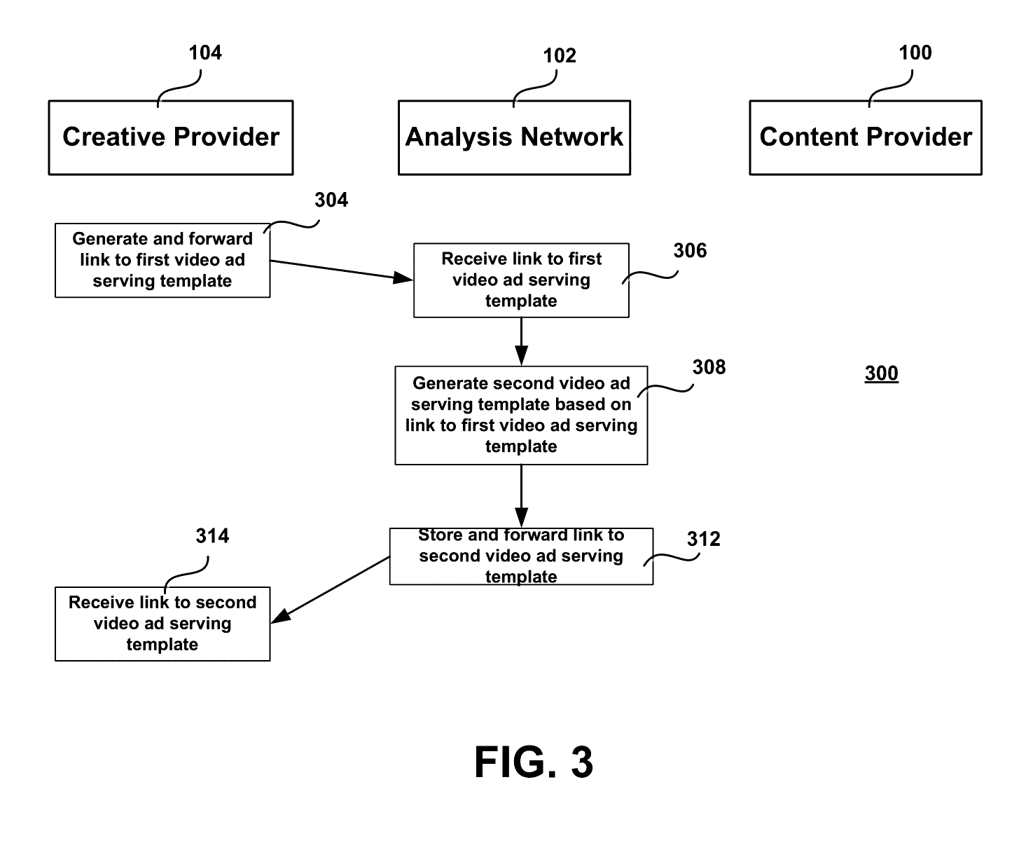

FIG. 3 illustrates an example of a process 300 for generating a second video ad serving template. As described previously, a video player 204 may receive callback instructions in the form of a metadata. The callback instructions may be in the form of a first video ad serving template. In some aspects, the first video ad serving template may be compliant with the Video Ad Serving Template (VAST) protocol, while in other aspects, the first video ad serving template may be any structured file. The structured file may be an Extensible Markup Language (XML) file or another markup language file that can be read by the video player 204.

In step 304, the first video ad serving template may be generated by the creative provider 104. The first video ad serving template may include a link to retrieve the creative 210 from the content provider 100 or the creative provider 104. The first video ad serving template may include instructions for playback of the creative 210, and callback instructions to generate first tracking information. In some aspects, the first tracking information may include an indication that playback of the video creative has begun, an indication that playback of the video creative has ended, an indication that playback of the video creative is at a first, second, or third quartile of a video creative duration, an indication that playback of the video creative is muted or un-muted, an indication that playback of the video creative is paused or un-paused, and/or an indication that playback of the video creative is in a full-screen mode. The first tracking information may also include other tracking information, such as, for example, whether the creative was visible on the webpage 200.

The creative provider 104 then forwards a link to the first video ad serving template to the analysis network 102. In step 306, the analysis network 102 receives the link to the first video ad serving template from the content provider 100. In step 308, the analysis network 102 generates the second video ad serving template based on the link to the first video ad serving template. The second video ad serving template includes instructions or a link to instructions for generating second tracking information to be sent to the analysis network 102. In some aspects, the instructions for generating the second tracking information of the second video ad serving template may the same as the instructions for generating the first tracking information of the first video ad serving template. For example, the instructions for generating the second tracking information may include code to track the same events tracked with respect to the first video ad serving template. In some aspects, the second tracking information may include an indication that playback of the video creative has begun, an indication that playback of the video creative has ended, an indication that playback of the video creative is at a first, second, or third quartile of a video creative duration, an indication that playback of the video creative is muted or un-muted, an indication that playback of the video creative is paused or un-paused, and/or an indication that playback of the video creative is in a full-screen mode. The second tracking information may also include other tracking information, such as, for example, whether the creative was visible on the webpage 200.

In other aspects, the instructions for generating the second tracking information of the second video ad serving template may be different from the instructions for generating the first tracking information of the first video ad serving template. For example, the second tracking information may include code to allow tracking of visibility information associated with the creative 210, such as location of the video player 204, visibility of the video player 204 on the screen of the client device, location of the video pane 206, visibility of the video pane 206, etc. The second tracking information may also include code to allow the visibility information to be transmitted every time a particular tracking event is triggered. The second tracking information may also include code to allow visibility information to be logged, accumulated and transmitted at a later time. The second tracking information may also include code to allow the client device to pre-process visibility information to detect and correct errors before displaying the creative 210.

In some aspects, the visibility information may also include criteria to determine whether the creative 210 has met a predetermined visibility threshold in order to be classified as “viewable.” The criteria may include determining whether a certain portion or percentage of the creative 210 was visible on the client device, determining whether the video content was played for a minimum threshold of time, or any other criteria to establish the predetermined visibility threshold. The instructions may also include code to allow an aggregate duration to be measured. For example, an aggregate time that the creative 210 was more than 50% in view may be measured. In addition, the visibility information may also include code to allow multiple durations to be measured, such as, for example, total time the creative 210 was at least partially in view, total time the creative 210 was more than 50% in view, and/or total time the creative 210 was 100% in view.

The instructions for generating the second tracking information of the second video ad serving template may be readable and executable by the video player 204. The instructions may be in a markup language, such as XML, or another structured language. The instructions may also be executable object code, such as in a small web file (SWF) format or in ActionScript format.

The second video ad serving template may also include the link to the first video ad serving template. In some aspects, the link to the first video ad serving template may be included in the instructions for generating second tracking information of the second video ad serving template as opposed or in addition to being included in the second video ad serving template. The video player 204 may execute the instructions for generating second tracking information of the second video ad serving template and retrieve the first video ad serving template from the creative provider 104.

In step 312, the analysis network 102 stores the second video ad serving template and forwards a link to the second video ad serving template to the creative provider 104. In step 314, the creative provider 104 receives and stores the link to the second video ad serving template to forward to a content provider 100 request the creative 210. In some aspects, the analysis network 100 may forward the second video ad serving template to the creative provider 104 in place of the link to the second video ad serving template.

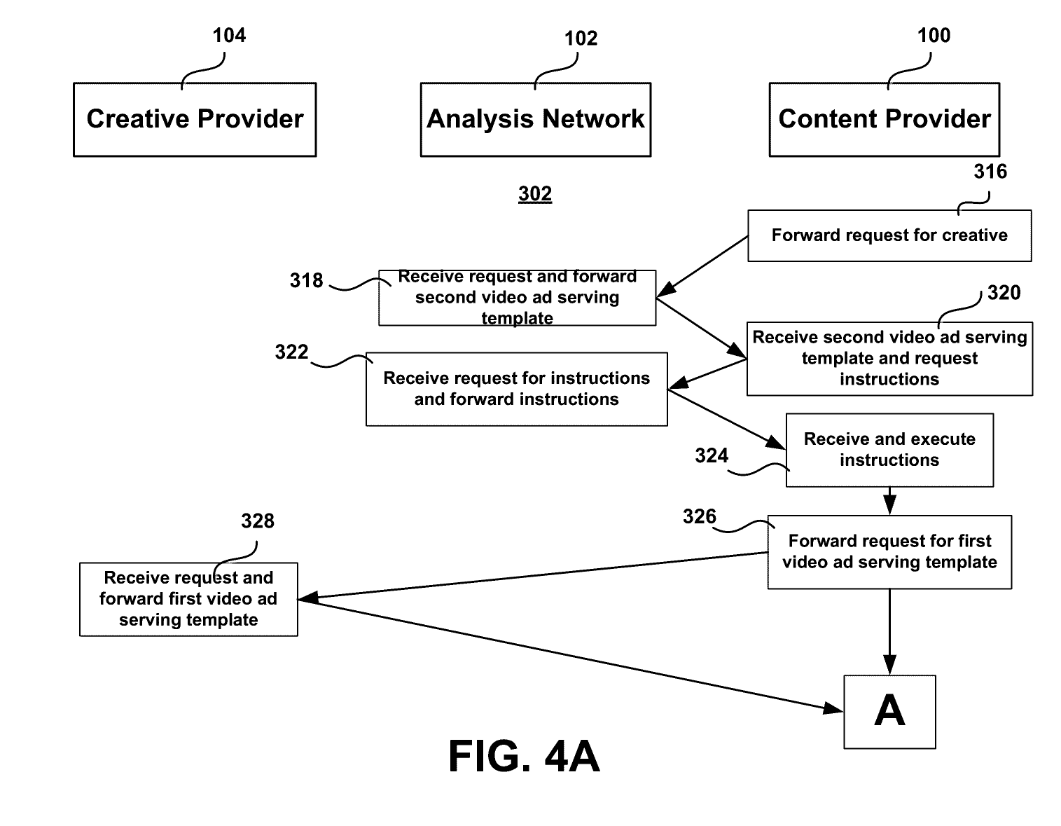

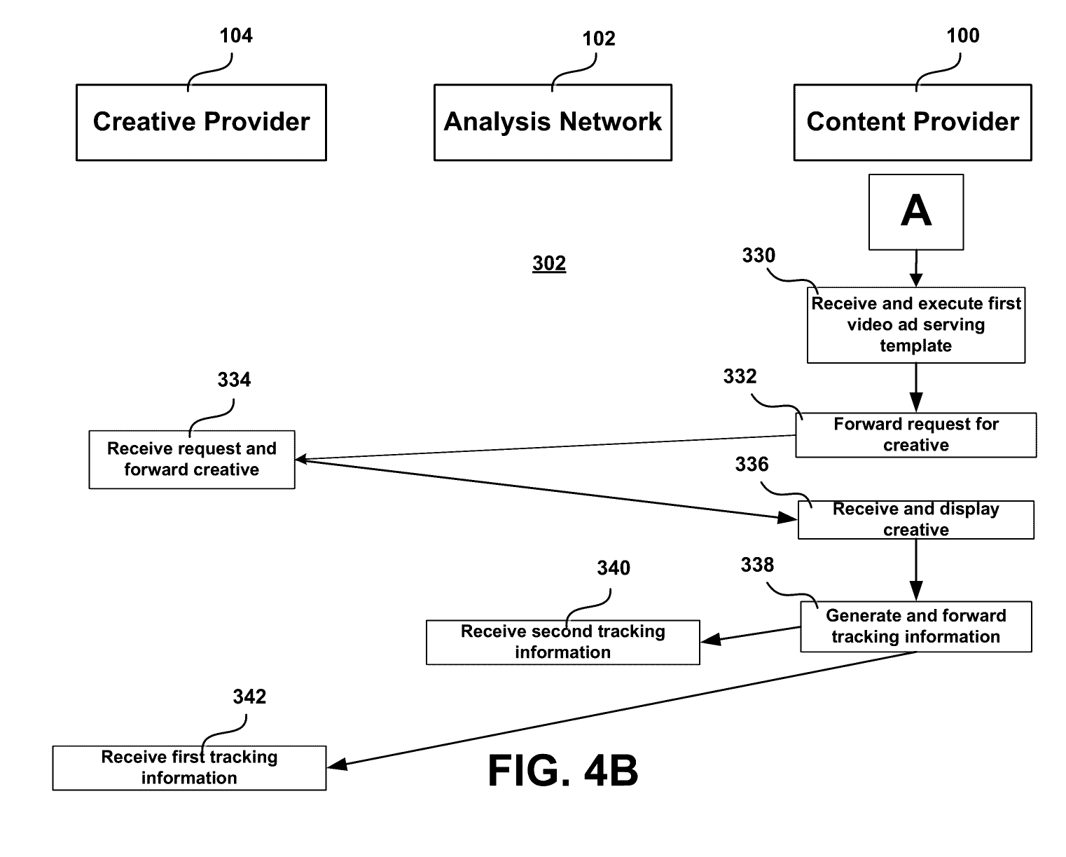

FIGS. 4A-4B illustrate an example of a process 302 for receiving tracking information at the analysis network 102. In step 316, when the webpage 200 or other content is requested by an end user, the content provider 100 forwards a request for the creative 210 using the second video ad serving template to the analysis network 102. The other content can be, for example, a mobile application or a news feed of a social network. If the webpage 200 or other content includes the video player 204, the video player 204 may make request the creative 210. The selection of the creative 210 to be played may be based on a variety of criteria, including demographic and topical information related to the end user, client and/or the content provider 100.

In step 318, the analysis network 102 receives the request for the creative 210. The creative provider 104 then forwards the second video ad serving template corresponding to the request to the content provider 100. In step 320, the content provider 100 receives the second video ad serving template that includes instructions or a link to instructions for generating second tracking information. If the second video ad serving template includes a link to the instructions, the content provider 100 may request the link and send a request to the analysis network 102 for the instructions for generating second tracking information. For example, in some aspects, the content provider 100 may send a request to the analysis network 102 for the SWF file including the instructions for generating second tracking information.

In step 322, the analysis network 102 receives the request for the instructions for generating second tracking information from the content provider 100. The analysis network 102 then forwards the corresponding instructions to the content provider 100. In step 324, the content provider 100 receives the instructions from the analysis network 102 and executes the instructions for generating second tracking information.

Referring back to step 320, the second video ad serving template may contain the actual instructions for generating the second tracking information, in place of the link to the instructions. If the second video ad serving template includes the instructions, such as callback instructions, the content provider 100 may execute the callback instructions without forwarding the request in step 320 by proceeding directly to step 324.

In step 326, the content provider 100 forwards a request for the first video ad serving template to the creative provider 104. In some aspects, the request for the first video ad serving template in step 326 may be made at the same time as the request for the instructions for generating the second tracking information in step 320, as the second video ad serving template includes the link to the first video ad serving template. In other aspects, the request for the first video ad serving template in step 326 may be made before or after the request for the instructions for generating the second tracking information in step 320. For example the link to the first video ad serving template may be included in the instructions for generating the second tracking information and, therefore, the request for the request for the first video ad serving template in step 326 may be made after the request for the instructions for generating the second tracking information in step 320.

In step 328, the creative provider 104 receives the request for the first video ad serving template from the content provider 100. The creative provider 104 then forwards the first video ad serving template to the content provider 100.

As shown in FIG. 4B, in step 330, the content provider 100 receives the first video ad serving template from the analysis network 102. The first video ad serving template includes a link to retrieve the creative 210 from the creative provider 104, instructions for playback of the creative 210, and/or instructions to generate first tracking information.

In step 332, the content provider 100 executes a link to retrieve the creative 210 and forward this request to the creative provider 104. In step 334, the creative provider 104 receives the request and forwards the creative 210 to the content provider 100. In some aspects, the request for the creative 210 may be forwarded to a different creative provider 104, such as another advertisement network.

In step 336, the content provider 100 receives and displays the creative 210 using the video player 204. In step 338, before, during, and after playback of the creative 210, the content provider 100 may execute the instructions for generating the first and second tracking information related to the creative 210. As described above, the instructions may include specific tracking events related to the playback of the creative 210, visibility information related to the creative 210, and/or other tracking information.

In step 338, the second tracking information is then forwarded to the analysis network 102 and the first tracking information is also forwarded to the creative provider 104. The second tracking information is received by the analysis network 102 in step 340 and the first tracking information is received by the creative provider 104 in step 342. Because the first video ad serving template is created by the creative provider 104 and the second video ad serving template is created by the analysis network 102, the instructions from the first video ad serving template provide the first tracking information to the creative provider 104, while the instructions from the second video ad serving template provide the second tracking information to the analysis network 102. The first tracking information forwarded to the creative provider 104 may be different from the second tracking information forwarded to the analysis network 102. In some aspects, the tracking information may be initially stored at the content provider 100 and forwarded to the creative provider 104, the analysis network 102, or another third-party at a later time.

Certain aspects of the process of FIGS. 3, 4A and 4B may be implemented as or using a computer program or set of programs. The computer programs may exist in a variety of forms both active and inactive. For example, the computer programs may exist as software program(s) comprised of program instructions in source code, object code, scripts, executable code or other formats, firmware programs(s), or hardware description language (HDL) files. Any of the above may be embodied on a non-transitory computer readable medium, which include storage devices, in compressed or uncompressed form. Exemplary computer readable storage devices may include conventional computer system random access memory (RAM), read-only memory (ROM), erasable, programmable memory (EPROM), electrically erasable, programmable memory (EEPROM), and magnetic or optical disks or tapes.

Certain aspects of the process of FIGS. 3, 4A and 4B may utilize or include a computer system, which may include one or more processors coupled to random access memory operating under control of or in conjunction with an operating system. The processors may be included in one or more servers, clusters, or other computers or hardware resources, or may be implemented using cloud-based resources. The processors may communicate with persistent memory, which may include a hard drive or disk array, to access or store program instructions or other data. The processors may be programmed or configured to execute computer-implemented instructions to perform the steps disclosed herein.

While the receiving of the tracking information at the analysis network has been described in terms of what may be considered to be specific aspects, this disclosure need not be limited to the disclosed aspects. Additional modifications and improvements may be apparent to those skilled in the art. As such, this disclosure is intended to cover various modifications and similar arrangements included within the spirit and scope of the claims, the scope of which should be accorded the broadest interpretation so as to encompass all such modifications and similar methods. The present disclosure should be considered as illustrative and not restrictive.

1. A computer-implemented method for receiving tracking information at an analysis network, the computer-implemented method comprising:
receiving, at the analysis network and from a creative provider, a first link to a first video ad serving template comprising first instructions for generating first tracking information and a second link to a video creative;
generating, based on the first link to the first video ad serving template, a second video ad serving template comprising:
the first link to the first video ad serving template comprising the first instructions for generating the first tracking information and the second link to the video creative, and
a third link to second instructions for generating second tracking information, the second tracking information being different from the first tracking information;
forwarding, from the analysis network and to the creative provider, a link to the second video ad serving template that is forwarded by the creative provider to a content provider;
receiving, at the analysis network and from the content provider, a request for the second instructions for generating the second tracking information;
forwarding, from the analysis network and to the content provider, the second instructions for generating the second tracking information; and
receiving, at the analysis network and from the content provider, the second tracking information generated by the second instructions.

2. The computer-implemented method of claim 1, wherein the second instructions cause the content provider to request the first video ad serving template from the creative provider.

3. The computer-implemented method of claim 2, further comprising:
receiving, at the creative provider and from the content provider, a request for the first video ad serving template; and
forwarding, from the creative provider and to the content provider, the first video ad serving template.

4. The computer-implemented method of claim 1, wherein the first tracking information is at least one of an indication that playback of the video creative begins, an indication that playback of the video creative has ended, an indication that playback of the video creative is at a first, second, or third quartile of a video creative duration, an indication that playback of the video creative is muted or un-muted, an indication that playback of the video creative is paused or un-paused, and an indication that playback of the video creative is in a full-screen mode.

5. The computer-implemented method of claim 1, wherein the second tracking information is at least one of an indication that playback of the video creative begins, an indication that playback of the video creative has ended, an indication that playback of the video creative is at a first, second, or third quartile of a video creative duration, an indication that playback of the video creative is muted or un-muted, an indication that playback of the video creative is paused or un-paused, and an indication that playback of the video creative is in a full-screen mode.

6. (canceled)

7. The computer-implemented method of claim 1, wherein the first instructions are configured to cause a processor of an end-user device to generate the first tracking information.

8. The computer-implemented method of claim 1, wherein the second instructions are configured to cause a processor of an end-user device to generate the second tracking information.

9. The computer-implemented method of claim 1, wherein the first instructions and the second instructions are compliant with the Video Player Ad-Serving Interface Definition standard.

10. The computer-implemented method of claim 1, further comprising analyzing the second tracking information to determine metrics for viewing of and interaction with the video creative.

11. The computer-implemented method of claim 10, wherein analyzing the second tracking information to determine the metrics for viewing of and interaction with the video creative comprises determining at least one of location of the video creative on a screen of a client device, visibility of the video creative on a screen of a client device, and whether a threshold of visibility for the video creative has been met.

12. A system for receiving tracking information at an analysis network, the system comprising at least one processor connected to at least one storage device, the system being configured to:
receive, at the analysis network and from a creative provider, a first link to a first video ad serving template comprising first instructions for generating first tracking information and a second link to a video creative;
generate, based on the first link to the first video ad serving template, a second video ad serving template comprising:
the first link to the first video ad serving template comprising the first instructions for generating the first tracking information and the second link to the video creative, and
a third link to second instructions for generating second tracking information, the second tracking information being different from the first tracking information;
forward, from the analysis network and to the creative provider, a link to the second video ad serving template that is forwarded by the creative provider to a content provider;
receive, at the analysis network and from a content provider, a request for the second instructions for generating the second tracking information;
forward, from the analysis network and to the content provider, the second instructions for generating the second tracking information; and
receive, at the analysis network and from the content provider, the second tracking information generated by the second instructions.

13. The system of claim 12, wherein the second instructions cause the content provider to request the first video ad serving template from the creative provider.

14. (canceled)

15. The system of claim 12, wherein the system is further configured to analyze the second tracking information to determine metrics for viewing of and interaction with the video creative.

16. The system of claim 15, wherein the system is configured to analyze the second tracking information to determine metrics for viewing of and interaction with the video creative by determining at least one of location of the video creative on a screen of a client device, visibility of the video creative on a screen of a client device, and whether a threshold of visibility for the video creative has been met.

17. A storage device storing a computer program for receiving tracking information at an analysis network, the computer program comprising one or more code segments that, when executed, cause at least one processor to:
receive, at the analysis network and from a creative provider, a first link to a first video ad serving template comprising first instructions for generating first tracking information and a second link to a video creative;
generate, based on the first link to the first video ad serving template, a second video ad serving template comprising:
the first link to the first video ad serving template comprising the first instructions for generating the first tracking information and the second link to the video creative, and
a third link to second instructions for generating second tracking information, the second tracking information being different from the first tracking information;
forward, from the analysis network and to the creative provider, a link to the second video ad serving template that is forwarded by the creative provider to a content provider;
receive, at the analysis network and from a content provider, a request for the second instructions for generating the second tracking information;
forward, from the analysis network and to the content provider, the second instructions for generating the second tracking information; and
receive, at the analysis network and from the content provider, the second tracking information generated by the second instructions.

18. The storage device of claim 17, wherein the second instructions cause the content provider to request the first video ad serving template from the creative provider.

19. (canceled)

20. The storage device of claim 17, wherein the computer program further comprises one or more code segments that, when executed, cause at least one processor to:
analyze the second tracking information to determine metrics for viewing of and interaction with the video creative.

21. The storage device of claim 20, wherein the computer program further comprises one or more code segments that, when executed, cause at least one processor to:
analyze the second tracking information to determine metrics for viewing of and interaction with the video creative by determining at least one of location of the video creative on a screen of a client device, visibility of the video creative on a screen of a client device, and whether a threshold of visibility for the video creative has been met.

22. The system of claim 12, wherein the first tracking information or the second tracking information is at least one of an indication that playback of the video creative begins, an indication that playback of the video creative has ended, an indication that playback of the video creative is at a first, second, or third quartile of a video creative duration, an indication that playback of the video creative is muted or un-muted, an indication that playback of the video creative is paused or un-paused, and an indication that playback of the video creative is in a full-screen mode.

23. The storage device of claim 17, wherein the first tracking information or the second tracking information is at least one of an indication that playback of the video creative begins, an indication that playback of the video creative has ended, an indication that playback of the video creative is at a first, second, or third quartile of a video creative duration, an indication that playback of the video creative is muted or un-muted, an indication that playback of the video creative is paused or un-paused, and an indication that playback of the video creative is in a full-screen mode.
